(19) United States
(12) Patent Application Publication
(10) Pub. No.: US 2007/0036364 A1
(43) Pub. Date: Feb. 15, 2007

(54) Sound field compensating apparatus and sound field compensating method

(75) Inventors: Masahiro Okuno, Kanagawa (JP); Yasuyuki Kino, Tokyo (JP); Tokihiko Sawashi, Tokyo (JP); Koji Kobayashi, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/496,511

(22) Filed: Aug. 1, 2006

(30) Foreign Application Priority Data
Aug. 11, 2005 (JP) 2005-232953

(51) Int. Cl. H04R 29/00

(52) U.S. Cl. 381/59

(57) ABSTRACT

The sound field compensating apparatus includes a section that generates sound-volume regulating test signal; a driving section that drives a speaker; a microphone that receives the output from the speaker; and a control section that processes an output signal of the microphone and that controls operations of respective sections. The sound-volume regulating test signal is a sum signal representative of the sum of single-frequency sinusoidal wave signals whose frequencies are set to the relationship of an integer ratio. The control section causes the driving section to drive the speaker by using the sound-volume regulating test signal to thereby detect signal levels of frequency components of the sinusoidal wave signals from output signals of the microphone. In accordance with an average value of the signal levels, the control section sets a measuring sound volume when the speaker is driven by using the measuring test signal.

### CROSS REFERENCES TO RELATED APPLICATIONS

The present invention contains subject matter related to Japanese Patent Application JP 2005-232953 filed in the Japanese Patent Office on Aug. 11, 2005, the entire contents of which being incorporated herein by reference.

### BACKGROUND OF THE INVENTION

1. Field of the Invention

The present invention relates to a sound field compensating apparatus and a sound field compensating method, and can be adapted to, for example, an in-vehicle audio system (or, a car audio system). More specifically, the invention relates to a technique in which, when compensating for sound field characteristics by reproducing a test signal through a speaker system, a speaker is driven by a sound-volume regulating test signal formed of a sum signal representative of the sum of single-frequency sinusoidal wave signals whose frequencies are set to the relationship of an integer ratio, and an output signal from the speaker is detected in accordance with an average value of signal levels of the respective frequency components to thereby set a sound volume in accordance with the measuring test signal, whereby to make it possible to appropriately set the sound volume without driving the speaker by using pink noise or white noise.

2. Description of the Related Art

Vehicle audio systems developed in recent years have a configuration that employs a subwoofer and a technique or method of compensating for various characteristics (inclusive of sound field regulation) by using a digital signal processor, whereby making it possible to produce music contents with enhanced audio quality.

Regarding such sound field regulation, a regulation method therefor has been proposed, such as disclosed in Japanese Unexamined Utility Model Registration Application Publication No. 6-13292. According to the disclosure, test signals using pink noise reproduced by a speaker are gathered by a microphone and are analyzed, whereby various sound field characteristics are measured, and further, the sound field characteristics are regulated in accordance with the measurement result. It can be contemplated that the white noise is used instead of the pink noise for the measurement of frequency characteristics as described above.

Such an in-vehicle audio system is used in a narrow, closed spacing, that is, a vehicle cabin interior, so that the sound field characteristics significantly varies depending on the vehicle mounting the system. As such, the sound field characteristics have to be regulated to various modes corresponding to vehicles. For satisfying the necessity, such an in-vehicle audio system is set up to enable the regulation of the sound field (characteristics) to various modes through operation of a user. Adaptation of a technique or method, such as disclosed in the cited publication (No. 6-13292), is contemplated to make it possible to appropriately regulate the sound field characteristics while reducing the burden on the user, consequently enabling further improvement of usability for users.

As a prerequisite condition for achieving the above, the sound volume of a respective speaker output should be appropriately regulated. More specifically, in the above-described case, the sound volume of the respective speaker should be appropriately regulated so that a microphone output with a sufficient S/N (signal to noise) ratio can be obtained within a range where the speaker output does not saturate across all frequency bands applied in the measurement of the characteristics. In particular, as shown in FIG. 7, since the in-vehicle audio system is provided in a narrow, closed spacing, the level variation of the speaker system is large, and the noise level due to air conditioner and the like is high, such that the sound volume should be regulated taking these factors into account. Shown in FIG. 7 is an example of the result obtained in an environment where a microphone is installed to a headrest of a driver's seat, and outputs from a speaker provided to a door on the side of the driver's seat are measured, in which a maximum level difference is about 10 [dB]. In FIG. 7, 0 [dB] on the vertical axis represents a gain value in a case where no influence of variations in the frequency characteristics was received. It is considered that, in the manner described above, the speaker is driven by using pink noise or white noise, and the signal levels of speaker outputs gathered by the speaker are determined, whereby the sound volumes can be appropriately set.

Nevertheless, however, a problem arises in that reproduction of pink noise or white noise results in the development of a very uncomfortable feeling in auditory sense for a user staying in a vehicle cabin. Under these circumstances, it is demanded that the sound volume can be appropriately set without driving the speaker by using pink noise or white noise.

### SUMMARY OF THE INVENTION

The present invention is made in view of the above-described circumstances, and it is desired to propose a sound field compensating apparatus and a sound field compensating method that are capable of appropriately setting the sound volume without driving a speaker by using pink noise or white noise when compensating for sound field characteristics by reproducing a test signal through a speaker system.

In order to address the problems described above, a one embodiment of the invention is a sound field compensating apparatus that drives a speaker by using a measuring test signal and that performs compensation for a characteristic of a sound field produced by the speaker through analysis of an output from the speaker. The apparatus includes a sound-volume regulating test signal generating section that generates a sound-volume regulating test signal; a driving section that drives the speaker; a microphone that receives the output from the speaker; and a control section that processes an output signal of the microphone and that controls operations of respective sections. The sound-volume regulating test signal is a sum signal representative of the sum of single-frequency sinusoidal wave signals whose frequencies are set to the relationship of an integer ratio. The control section causes the driving section to drive the speaker by using the sound-volume regulating test signal to thereby detect signal levels of frequency components of the sinusoidal wave signals from output signals of the microphone, and in accordance with an average value of the signal levels, sets a measuring sound volume in an event that the speaker is driven by using the measuring test signal.

Another embodiment of the invention is a sound field compensating method that drives a speaker by using a measuring test signal and that performs compensation for a characteristic of a sound field produced by the speaker through analysis of an output from the speaker. The method includes a measuring-sound-volume setting step that sets a sound volume for driving the speaker by using the measuring test signal in a manner that the speaker is driven by using a sound-volume regulating test signal to thereby analyze the output from the speaker. The measuring-sound-volume setting step includes a speaker driving step that drives the speaker by using the sound-volume regulating test signal formed of a sum signal representative of the sum of single-frequency sinusoidal wave signals whose frequencies are set to the relationship of an integer ratio; a receiving step that receives through a microphone the output from the speaker driven by the speaker driving step; a signal-level detecting step that detects signal levels of frequency components of the sinusoidal wave signals from output signals of the microphone, thereby to detect an average value of the signal levels; and a sound-volume setting step that sets the measuring sound volume in accordance with the average value detected by the signal-level detecting step.

According to the configuration of the one embodiment, the sound field compensating apparatus drives a speaker by using the measuring test signal and performs compensation for the characteristic of the sound field produced by the speaker through the analysis of the output from the speaker. The apparatus includes the sound-volume regulating test signal generating section that generates the sound-volume regulating test signal; the driving section that drives the speaker; the microphone that receives the output from the speaker; and the control section that processes an output signal of the microphone and that controls operations of respective sections. The sound-volume regulating test signal is the sum signal representative of the sum of the single-frequency sinusoidal wave signals whose frequencies are set to the relationship of an integer ratio. The control section causes the driving section to drive the speaker by using the sound-volume regulating test signal to thereby detect signal levels of frequency components of the sinusoidal wave signals from output signals of the microphone, and in accordance with an average value of the signal levels, sets a measuring sound volume in an event that the speaker is driven by using the measuring test signal. Thereby, the sound volume can be set without driving the speaker by using pink noise or white noise. Further, the sound-volume regulating test signal is the sum signal representative of the sum of the single-frequency sinusoidal wave signals whose frequencies are set to the relationship of an integer ratio. Thereby, the speaker can be driven in a wide frequency band reproducible by the speaker and the speaker output in a respective-frequency can be verified by setting the sinusoidal wave signals, similarly to the case of driving the speaker by using pink noise or white noise. Further, since the process is executed by using the average value, the influence of noise can be avoided, whereby the sound volume can be appropriately set.

According to the other embodiment, a sound field compensating method can be provided that, when compensating for the characteristic of the sound field by using the test signal reproduced with the speaker system, is capable of appropriately setting the sound volume without driving the speaker by using pink noise or white noise.

Consequently, as an advantage, according to the embodiments of the invention, a sound field compensating method can be provided that, when compensating for the characteristic of the sound field by using the test signal reproduced with the speaker system, is capable of appropriately setting the sound volume without driving the speaker by using pink noise or white noise.

### BRIEF DESCRIPTION OF THE DRAWINGS

In the accompanying drawings,

FIG. 1 is a flowchart diagram showing a processing procedure of a specific sound volume regulation process of a digital signal processor of an in-vehicle audio system according to a first embodiment of the invention;

FIG. 2 is a block diagram showing the in-vehicle audio system according to the first embodiment of the invention;

FIG. 3 is a plan view showing a speaker system of the in-vehicle audio system;

FIG. 4 is a flowchart diagram showing a processing procedure of the digital signal processor of the in-vehicle audio system shown in FIG. 2;

FIG. 5 is a characteristic curve diagram showing sound-volume setting test signal in the in-vehicle audio system shown in FIG. 2;

FIG. 6 is a characteristic curve diagram showing a response in accordance with the test signal shown in FIG. 5; and

FIG. 7 is a characteristic curve diagram showing frequency characteristics of the speaker system of the in-vehicle audio system.

### DETAILED DESCRIPTION OF THE PREFERRED EMBODIMENTS

Embodiments of the invention will be described with reference to the applicable drawings.

### First Embodiment

(1) Configuration of Embodiment

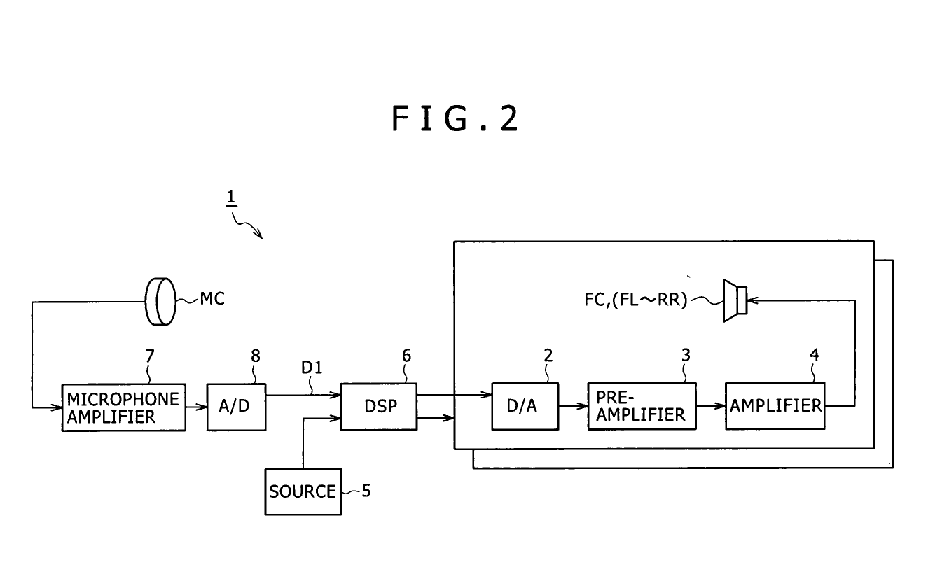

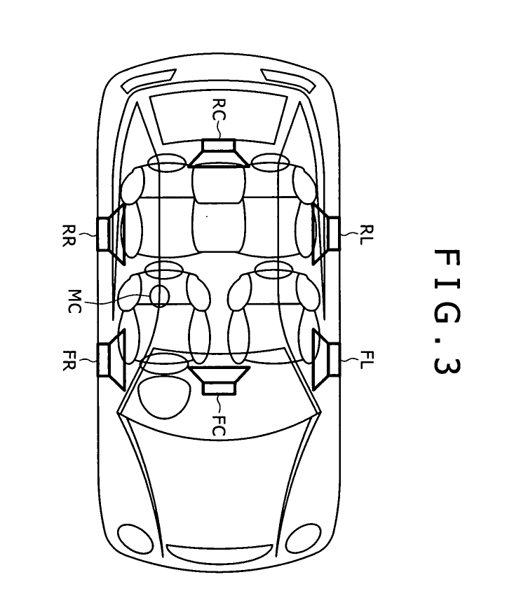

FIG. 2 is a block diagram showing an in-vehicle audio system 1 according to a first embodiment of the invention, and FIG. 3 is a plan view showing a speaker system of the in-vehicle audio system 1. The in-vehicle audio system 1 provides a user with music contents through 5.1 channels. With reference to FIG. 3, in the in-vehicle audio system 1, a speaker FC corresponding to a front center channel is provided in a front and central portion of a front seat. Speakers FR and FL corresponding to front right and left channels are provided to front right and left doors, respectively. On the rear side, speakers RL and RR corresponding to rear right and left channels are provided to rear right and left doors, respectively. In addition, a subwoofer RC is provided to a rear, central portion of a rear seat. A microphone MC for picking up outputs of the speakers FC, FL, FR, RL, and RR is disposed near a portion where the head of a driver is placed on a driver's seat.

With these components, a digital-analog (D/A) converter circuit 2 (shown as “D/A”), a pre-amplifier 3, and an amplifier 4 are provided in the in-vehicle audio system 1. The D/A converter circuit 2 performs a digital-to-analog conversion of audio data and outputs a resultant audio signal in units of the respective one of the speakers FC, FL, FR, RL, and RR. The pre-amplifier 3 sets, for example, the sound volume of the audio signal that is output from the D/A converter circuit 2. The amplifier 4 drives the corresponding speaker in accordance with an output signal of the pre-amplifier 3. A source 5, such as an optical disk player, of music contents is provided. In addition, a digital signal processor 6 (shown as “DSP”) is provided that processes audio data output from the source 5 and outputs the resultant signal to a system of the respective speaker.

The digital signal processor 6 compensates for, for example, the frequency characteristic of audio data in processing of the audio data, thereby to compensate for the sound field of the respective speaker FC, FL, FR, RL, RR so that the sound field formed of the respective speaker FC, FL, FR, RL, RR is optimized. In response to an instruction given by a user, the digital signal processor 6 preliminarily executes a processing program relative to setting of a sound field, thereby to set the compensation reference of the audio data in accordance with the output of the respective speaker FC, FL, FR, RL, RR received through the microphone MC. Thereby, according to the present embodiment, the processing program is provided in the state preinstalled in the in-vehicle audio system 1. However, instead of the provision in the pre-installed manner, the processing program may be provided through a network, such as Internet, allowing users to download. Still alternatively, the processing program may be provided by being recorded in any one of various recording mediums, such as an optical disk, a magnetic disk, and a memory card.

Thereby, in the in-vehicle audio system 1, a microphone amplifier 7 amplifies the output signal of the microphone MC in accordance with a predetermined gain and outputs the amplified signal, and an analog-digital converter circuit 8 (“A/D”) performs an analog-digital conversion of the output signal of the microphone MC and thereby outputs received-audio data D1.

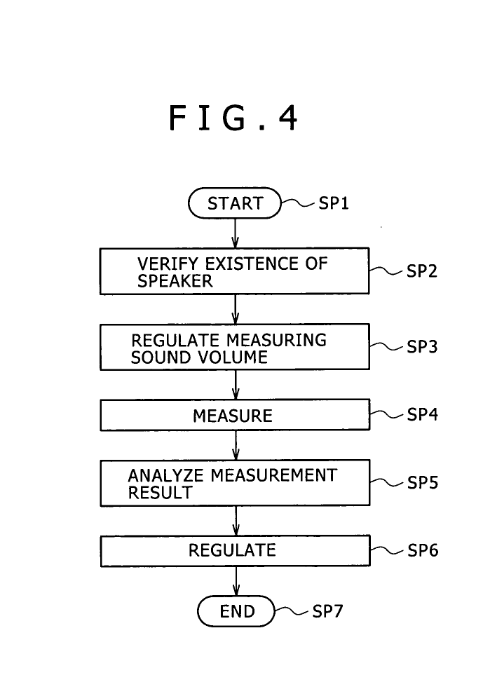

FIG. 4 is a flowchart diagram showing a processing procedure that is carried out by the digital signal processor 6 in accordance with the processing program for the sound field setting. Upon start of the processing procedure, the digital signal processor 6 (or the process thereby) shifts from step SP1 to step SP2 and executes an existence verification process of a speaker. More specifically, the digital signal processor 6 sequentially and selectively outputs a test signal to the respective system through a signal generator provided in the digital signal processor 6, determines a variation of the signal level of received-audio data D1 associated with the power of the test signal, and determines whether or not to be able to acquire a response from a respective microphone MC. Thereby, the digital signal processor 6 verifies the existence of the speaker.

Subsequently, the digital signal processor 6 shifts to step SP3, and sets a sound volume for being used in the measurement of the characteristics of the respective system. In this case also, similarly as above, the digital signal processor 6 sequentially and selectively outputs (through the signal generator) a test signal to the respective system, determines the signal level of received-audio data D1 associated with the power of the test signal, and then sets, in units of the respective system, a sound volume for being used to carry out the measurement of the characteristics in accordance with the determination result.

Subsequently, the digital signal processor 6 shifts to step SP4 and executes the measurement. In this case also, the digital signal processor 6 sequentially and selectively outputs a test signal to respective system and retrieves received-audio data D1 associated with the power of the test signal, and records the retrieved received-audio data D1 into a memory provided in itself (digital signal processor 6). Then, at subsequent step SP5 the digital signal processor 6 performs an analysis of the received-audio data D1 recorded in the memory. Through the analysis at step SP5, the digital signal processor 6 performs a measurement of a propagation time period of a respective speaker output to the microphone MC, and performs a measurement of a frequency characteristic of the respective speaker output.

Then, the digital signal processor 6 shifts to step SP6 and sets an amount of compensation for the audio data for the respective system in accordance with the various measurement results obtained at step SP5. More specifically, in accordance with, among the measurement results obtained at step SP5, the measurement result of the propagation time period of the respective speaker output to the microphone MC, the digital signal processor 6 sets a delay time into the audio data for the respective system to be compensated for an inter-system difference in the time period for the speaker output to reach the ear of the driver. Thereby, the process of regulation so-called “time alignment” is executed. Further, in accordance with the measurement results at step SP5, a frequency characteristic for the audio data compensation becomes a desired frequency characteristic. In the present case, the desired frequency characteristic refers to a flat frequency characteristic.

After having set the various characteristics in the above-described manners, the digital signal processor 6 shifts to step SP7 and terminates the processing procedure, whereby starting processes of the audio data associated with the respective system in accordance with the characteristics having been set through the series of the processes described above.

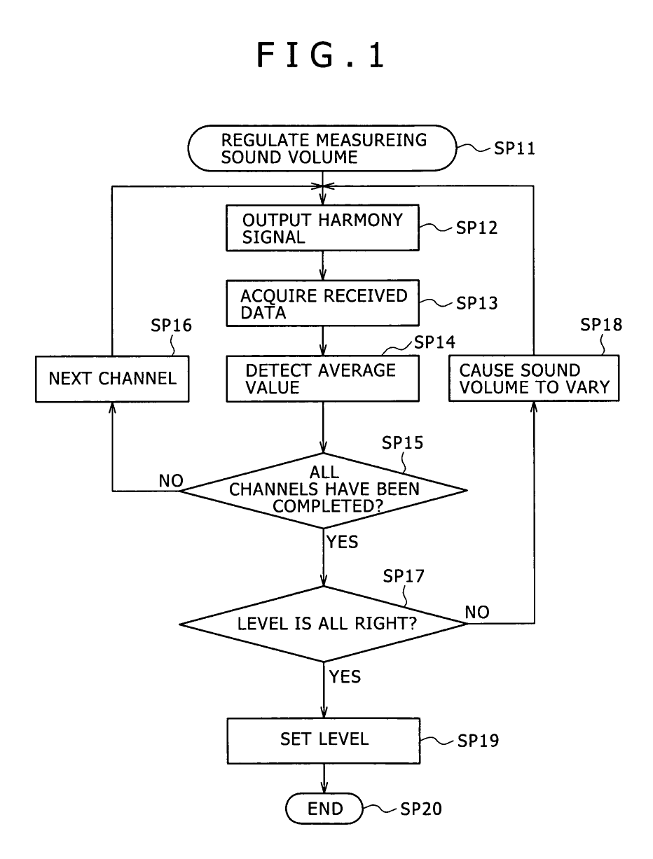

FIG. 1 is a flowchart diagram showing in detail a sound volume regulation process in accordance with step SP3 of the processing procedure shown in FIG. 4. In this processing procedure, the digital signal processor 6 shifts from step SP11 to step SP12, at which it outputs a test signal to one of six systems associated with the speakers FC, FL, FR, RL, and RR.

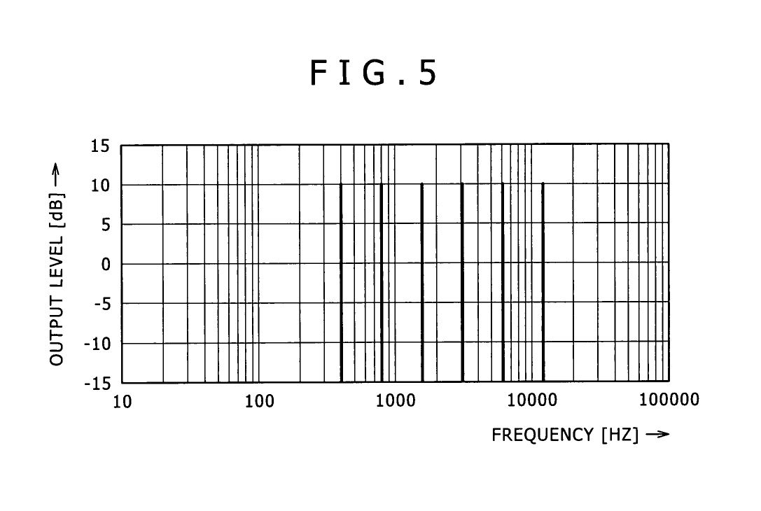

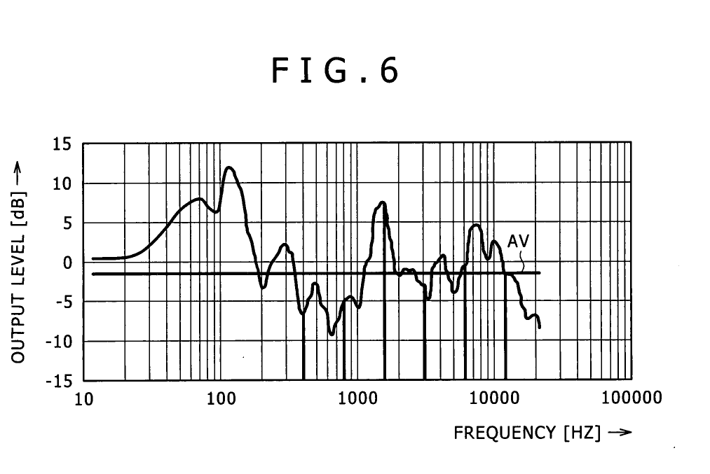

With reference to FIG. 5, in the present embodiment, a sum signal representative of the sum of single-frequency sinusoidal wave signals whose frequencies are set to the relationship of an integer ratio is allocated for the test signal. More specifically, the frequencies of the sinusoidal wave signals are set so that the frequency ratio is 1:2 between signals adjacent in frequency. According to this arrangement, when a frequency of a sinusoidal wave signal with a lowest frequency is f0, the frequency of an n-th sinusoidal wave signal from the sinusoidal wave signal of the frequency f0 is represented as (n−1)×f0. In a range not developing uncomfortable feeling in the auditory sense, the frequency ratio between sinusoidal wave signals adjacent in the frequency can be set to various ratios of, for example, 1:3 and 1:4. Further, the test signal is set to cover substantially the frequency bands of speakers being subjected to testing, such that the number of single-frequency sinusoidal wave signals and the frequencies are set corresponding to the speakers. Shown in FIG. 6 is an example of a test signal that is routed for driving the speakers excepting the subwoofer RC and that the frequencies of respective sinusoidal wave signals therefor are set to, in the order from the lower side, 400 Hz, 800 Hz, 1600 Hz, 3200 Hz, 6400 Hz, and 12800 Hz.

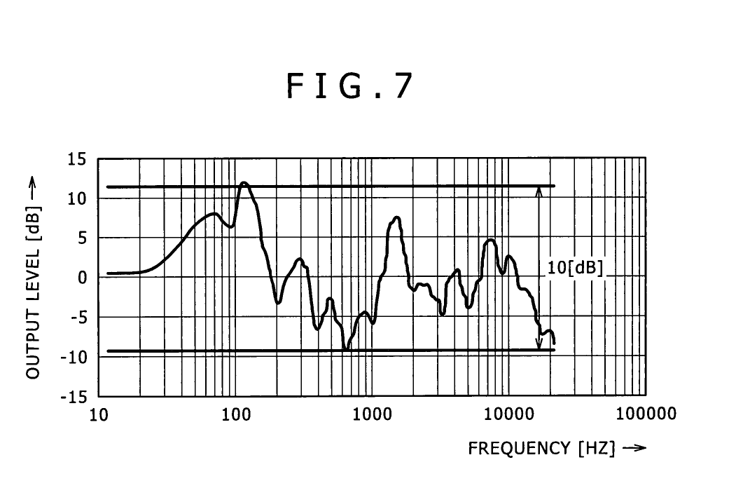

Subsequently, the digital signal processor 6 shifts to step SP13 and records into the memory received-audio data D1 that is picked up from the microphone MC. At subsequent step SP14, as shown in FIG. 7, through analysis of the received-audio data D1 recorded in the memory, a signal level of the frequency band associated with the respective sinusoidal wave signal of the test signal is detected, and an average value AV at the signal level is calculated. In this case, a high speed Fourier transform is used for the analysis of the received-audio data D1.

Subsequently, the digital signal processor 6 shifts to step SP15, at which it determines whether or not the process of all the systems has been completed. If at this step a negative result is received, the digital signal processor 6 shifts from step SP15 to step SP16, at which it shifts the processing target to a subsequent system, and then returns to step SP12.

In this manner, the digital signal processor 6 iteratively performs steps SP12 to SP15 for all the six systems of the speakers FC, FL, FR, RL, and RR, thereby to detect responses by using the test signal. In the series of the processes, in order that a melody is reproduced, while maintaining the frequency relationship of the integer ratio across the respective sinusoidal wave signals, the digital signal processor 6 causes the frequency of the test signal to vary each time steps SP12 to SP15 are iterated.

When having detected responses on all the systems, the digital signal processor 6 shifts from step SP15 to step SP17, at which it determines whether or not the average value AV calculated at step SP14 is a reference level. The reference level is a level at which, even when the frequency characteristic in a respective speaker system is significantly varied, the speaker output does not saturate at any frequency, but a sufficient S/N ratio can be secured at the all frequency bands. For example, the reference level is set to a value determined in accordance with measured values in in-vehicle audio systems mounted in various vehicles.

When having received a negative result, the digital signal processor 6 shifts from step SP17 to step SP18, at which it again sets a sound volume for driving of a speaker of a system not at the reference level so that the value approaches towards the reference level. Then, the digital signal processor 6 returns to step SP12.

Otherwise, when the average value of signal levels of the all systems has reached the reference level, the digital signal processor 6 shifts from step SP16 to step SP19. At step SP19, the digital signal processor 6 sets the set value of the sound volume, at which the average value becomes the reference level, to the sound volume in the present measurement, it then shifts to step SP20 and terminates the processing procedure.

(2) Operation of Embodiment

In the in-vehicle audio system 1 (in FIG. 2) in the configuration described above, audio data of a music contents being supplied from the source 5 is processed by the digital signal processor 6, and processed audio data is output therefrom to drive systems corresponding to the speakers FC, FL, FR, RL, and RR.

In the respective drive system, the audio data output from the digital signal processor 6 is converted by the D/A converter circuit 2 to an analog signal, then the sound volume, for example, is compensated for by the pre-amplifier 3, and a speaker corresponding to an output signal of the pre-amplifier 3 is driven. Thereby, in the in-vehicle audio system 1, the music contents reproduced from the source 5 is provided to the user.

The in-vehicle audio system 1 described above is used by being mounted in a vehicle, and the interior spacing of the vehicle is narrow, such that, for example, resonation occurs at a specific frequency. Consequently, compared to the case of an indoor (in-house) audiovisual or listening environment, the frequency characteristics are significantly deteriorated. In addition, listening points also are not always optimal. For example, a vehicle driver in most cases listens to music contents in a position close to the speaker FR on the right-side front (FIG. 3), such that the sound image localization also is inaccurate.

As such, in the in-vehicle audio system 1, sound field setting is executed by the digital signal processor 6 through the user operation; the sound field characteristic is measured by the execution; and in accordance with the measurement result, the frequency characteristic associated with driving of the respective speaker is measured; and the delay time of the audio data associated with the respective speaker is set (see FIG. 4). Thereby, the sound field characteristics are set to create optimal sound fields.

More specifically, in the in-vehicle audio system 1, at the outset, connection to the respective system is verified in the manner that the test signal is sequentially and selectively output to thereby verify a response received through the microphone MC in units of the system associated with driving of the respective one of the speakers FC, FL, FR, RL, and RR. Then, in units of the speaker verified for the connection, and the test signal is sequentially and selectively output, and a response received through the microphone MC is verified, whereby the sound volume is set. Further, in accordance with the sound volume, the respective system is sequentially and selectively driven by the characteristic-measuring test signal, and the characteristic associated with the sound field is sequentially measured the analysis of the response received through the microphone MC.

In the series of the processes, in the in-vehicle audio system 1, a sound-volume regulating test signal formed of a sum signal representative of the sum of single-frequency sinusoidal wave signals whose frequencies are set to the relationship of an integer ratio is generated by the digital signal processor 6, and the respective speaker is sequentially driven by the test signal. In addition, a signal level of a respective frequency component of the respective sinusoidal wave signal is detected from a response received through the microphone MC, and the appropriateness of the sound volume is determined in accordance with an average value of the signal levels, whereby the respective sound volume is set (FIG. 1).

Thereby, in the in-vehicle audio system 1, the sound volume measured without using pink noise or white noise, such that it is possible to prevent a user's uncomfortable feeling that is developed by the use of the pink noise or white noise.

Consequently, when setting the sound volume in accordance with the sound-volume regulating test signal formed of the sum signal representative of the sum of the single-frequency sinusoidal wave signals whose frequencies are set to the relationship of an integer ratio, the speaker can be driven in a wide frequency band reproducible by the speaker and the speaker output in a respective frequency can be verified by setting the frequencies and number of the sinusoidal wave signals, similarly to the case of driving the speaker by using pink noise or white noise. Further, the execution using the average value of the signal levels makes it possible to avoid the influence of noise, therefore enabling appropriate setting of the sound volume.

In the present embodiment, the processes for setting the sound volume is executed by sequentially shifting the speaker. If a sound volume thus set for a speaker is found inappropriate, a collective setting process is executed for the speaker. In this event, in the in-vehicle audio system 1, the digital signal processor 6 generates the test signal by causing the frequency to vary in conjunction with shifting of the speaker, whereby melody is reproduced and the series of the processes are executed. Thereby, driving of the speaker by using the sound-field regulating test signal is implemented without being recognized by the user, such that the problem of user's uncomfortable feeling can be avoided.

(3) Advantages and Effects of Embodiment

According to the configuration described above, in the event that a respective speaker is driven by a sound-volume regulating test signal formed of a sum signal representative of the sum of single-frequency sinusoidal wave signals whose frequencies are set to the relationship of an integer ratio, and an output signal from the speaker is detected in accordance with an average value of signal levels of the respective frequency components to thereby set a sound volume in accordance with the measuring test signal, the sound volume can be appropriately set without driving the speaker by using pink noise or white noise.

Further, the sound volume is set in units of the speaker, and the test signal is generated by causing the frequency to vary in conjunction with shifting of the speaker. Consequently, driving of the speaker by using the sound-field regulating test signal is implemented without being recognized by the user, such that the problem of user's uncomfortable feeling can be avoided.

### Second Embodiment

In a second embodiment, the sound-volume regulating test signal according to the first embodiment described above is used also for the connection-verifying test signal described above in conjunction with step SP2 shown in FIG. 4. Further, also in the connection-verifying process, the frequency of the test signal is shifted in conjunction with shifting of the drive system for the speaker.

As such, the above-described processes of steps SP2 and SP3 shown in FIG. 4 can be synchronously executed.

According to the second embodiment, the sum signal representative of the sum of single-frequency sinusoidal wave signals whose frequencies are set to the relationship of an integer ratio used for the connection-verifying test signal. Thereby, the configuration of the digital signal processor 6 can be simplified.

Further, driving of the speaker by using the connection-verifying test signal can be implemented without being recognized by the user.

### Third Embodiment

The first, although second embodiment has been described with reference to the case where the invention is adapted to the 5.1-channel audio system, the invention is not limited thereto. The invention can be widely adapted to multichannel audio systems with various other numbers of channels.

Further, although the first, second embodiment has been described with reference to the case where the frequency characteristics and delay times of the plurality of channels are collectively regulated by the digital signal processor, the invention is not limited thereto. The invention can be widely adapted even to the case where the regulation is executed in units of the channel.

Further, although the first, second embodiment has been described with reference to the case where the invention is adapted to the in-vehicle audio system and the sound field is compensated for, the invention is not limited thereto. The invention can be widely adapted even to the case where the invention is adapted to an in-house audio system and the sound field is compensated.

The invention can be adapted to in-vehicle audio systems.

It should be understood by those skilled in the art that various modifications, combinations, sub-combinations and alterations may occur depending on design requirements and other factors insofar as they are within the scope of the appended claims or the equivalents thereof.

What is claimed is:

1. A sound field compensating apparatus that drives a speaker by using a measuring test signal and that performs compensation for a characteristic of a sound field produced by the speaker through analysis of an output from the speaker, the apparatus comprising:
a sound-volume regulating test signal generating section that generates a sound-volume regulating test-signal;
a driving section that drives the speaker;
a microphone that receives the output from the speaker; and
a control section that processes an output signal of the microphone and that controls operations of respective sections,
wherein:
the sound-volume regulating test signal is a sum signal representative of the sum of single-frequency sinusoidal wave signals whose frequencies are set to the relationship of an integer ratio; and
the control section causes the driving section to drive the speaker by using the sound-volume regulating test signal to thereby detect signal levels of frequency components of the sinusoidal wave signals from output signals of the microphone, and in accordance with an average value of the signal levels, sets a measuring sound volume in an event that the speaker is driven by using the measuring test signal.

2. A sound field compensating apparatus according to claim 1, wherein:
a plurality of the speakers are provided;
the driving section includes a drive system that drives the respective speaker;
the control section and the driving section sequentially shifts the respective drive system and drives the speaker by using the sound-volume regulating test signal, thereby to set the measuring sound volume; and
the test signal generating section causes the frequency of the respective sinusoidal wave signal to vary in conjunction with shifting of the respective drive system.

3. A sound field compensating apparatus according to claim 2, wherein:
the sound field compensating apparatus includes a connection-verifying test signal generating circuit that generates a connection-verifying test signal;
the control section and the driving section sequentially shift the respective drive system and determine the output signal of the microphone by driving the speaker by using the connection-verifying test signal, thereby to detect a drive system to which the speaker is connected to, and set the measuring sound volume of the drive system; and
the connection-verifying test signal is a sum signal representative of the sum of single-frequency sinusoidal wave signals whose frequencies are set to the relationship of an integer ratio.

4. A sound field compensating apparatus according to claim 1, wherein the compensation for the characteristic of the sound field is compensation for a frequency characteristic.

5. A sound field compensating method that drives a speaker by using a measuring test signal and that performs compensation for a characteristic of a sound field produced by the speaker through analysis of an output from the speaker, the method comprising the steps of:
setting a sound volume for driving the speaker by using the measuring test signal in a manner that the speaker is driven by using a sound-volume regulating test signal to thereby analyze the output from the speaker,
wherein the measuring-sound-volume setting step includes the substeps of:
driving the speaker by using the sound-volume regulating test signal formed of a sum signal representative of the sum of single-frequency sinusoidal wave signals whose frequencies are set to the relationship of an integer ratio;
receiving through a microphone the output from the speaker driven by the speaker driving step;
detecting signal levels of frequency components of the sinusoidal wave signals from output signals of the microphone, thereby to detect an average value of the signal levels; and
setting the measuring sound volume in accordance with the average value detected by the signal-level detecting step.
